(19) United States
(12) Patent Application Publication
(10) Pub. No.: US 2018/0213715 A1
(43) Pub. Date: Aug. 2, 2018

(54) Reversible Rake

(71) Applicant: John Dang Pendlebury, Bellingham, MA (US)

(72) Inventor: John Dang Pendlebury, Bellingham, MA (US)

(21) Appl. No.: 15/882,809

(22) Filed: Jan. 29, 2018

Related U.S. Application Data
(60) Provisional application No. 62/451,098, filed on Jan. 27, 2017.

(51) Int. Cl. A01D 7/06; A01D 7/02

(52) U.S. Cl. CPC A01D 7/06; A01D 7/02

(57) ABSTRACT

An improved yard rake that can be pulled or pushed in a back and forth one-stroke motion to move yard debris, without altering the orientation of the rake. The rake permits usage that is less tiring and requires less effort to collect yard debris.

### CROSS REFERENCE TO RELATED APPLICATION

This application claims the benefit of U.S. Provisional Patent Application No. 62/451,098, filed Jan. 27, 2017, the contents of which are incorporated herein by reference.

### FIELD OF THE INVENTION

The invention relates to an improved yard rake that can be pulled or pushed in a back and forth motion to move yard debris, without altering the configuration of the rake.

### BACKGROUND OF INVENTION

Collecting yard debris, such as cut grass, fallen leaves, mulch, small rocks, and twigs is a time-consuming and potentially exhausting chore.

The are many ways to collect yard debris, but the oldest, and most common way is the use of a rake. The rake is an old yard tool with an elongated, straight, rigid handle attached to a rake body. The handle is typically made of strong but lightweight materials such as wood, aluminum, light gauge steel, and hard plastic. Multiple tines, made of metal or plastic, extend outwardly from the rake body for drawing leaves, grass clippings, and small twigs.

A traditional rake is operated in a pulling motion from the handle in one of two positions. In the first position, the handle is held at a 45-degree angle with respect to the ground for light to medium raking. In this position, less pulling force is applied downward on the rake, but it can be extended over a further area to collect leaves. However, since less downward pulling force is applied, the rake tines cannot move as many leaves. Furthermore, if the rake is extended too far the debris builds up under the tines, lifting the tines up off the ground resulting in less movement of the debris.

In the second position, the handle is held at 65 to 75 degrees with respect to the ground for heavy raking requiring greater pulling force. In this position, more pulling force is applied downward on the rake, but it also requires more work to operate. The handle is pulled down to force the body of the rake down, bending the tines to create a springing action to move the debris in the desired direction.

While the rake is an effective too for collecting leaves, the amount of leaves and the size of the yard can make usage of a rake onerous. Each collection of all the leaves with a rake can take hours to a whole day. Furthermore, extensive fallen leaves, or wet leaves can produce natural, heavy piles that are difficult to move with a rake.

Other solutions, such a leaf blowers or leaf vacuums can decrease the time and effort needed to collect leaves, but these items usually come at a significant cost and aren't as flexible as rakes in reaching all areas of a yard.

The subject invention discloses an improved yard rake that requires less effort to operate and allows a user to move heavy or large piles of yard debris with pushing motions.

### SUMMARY OF THE INVENTION

There are additional features of the invention that will be described hereinafter and which will form the subject matter of the claims appended hereto. In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

The subject invention discloses a yard rake comprising: an elongated, substantially rigid handle extending from a proximal end to a distal end; a rake body secured on the distal end of the handle; a plurality of flexible tines attached to and extending outwardly from a distal end of the rake body, wherein each tine comprises a first segment and a second segment, wherein the first segment of each tine is proximal to and substantially parallel with the rake body and the elongated handle, wherein the second segment of each tine is at an angle of sixty degrees with respect to the rake body and the elongated handle; wherein the handle is placed at an angle to a ground surface between nineteen and thirty-one degrees, such that the second segments of the plurality of tines are substantially perpendicular to the ground surface, and the handle is pulled in a proximal direction to pull yard debris; and further wherein the handle is pushed in a distal direction to push yard debris with the second segments of the plurality of tines.

The subject invention also discloses a yard rake comprising: an elongated, substantially rigid handle extending from a proximal end to a distal end; a rake body secured on the distal end of the handle; a plurality of flexible tines attached to and extending outwardly from a distal end of the rake body, wherein each tine comprises a first segment and a second segment, wherein the first segment of each tine is proximal to and substantially parallel with the rake body and the elongated handle, wherein the second segment of each tine is at an angle of sixty degrees with respect to the rake body and the elongated handle; wherein the handle is placed at an angle to a ground surface between nineteen and thirty-one degrees, such that the second segments of the plurality of tines are substantially perpendicular to the ground surface, and the handle is pulled in a proximal direction to pull yard debris; and further wherein the handle is pushed in a distal direction to compress the second segments of the plurality of tines to spring forward and push yard debris away from the rake.

The subject invention further discloses a yard rake comprising: an elongated, substantially rigid handle extending from a proximal end to a distal end; a rake body secured on the distal end of the handle; a plurality of flexible tines attached to and extending outwardly from a distal end of the rake body, wherein each tine comprises a first segment and a second segment, wherein the first segment of each tine is proximal to and substantially parallel with the rake body and the elongated handle, wherein the second segment of each tine is at an angle of sixty degrees with respect to the rake body and the elongated handle; wherein the handle is placed at an angle to a ground surface between nineteen and thirty-one degrees, such that the second segments of the plurality of tines are substantially perpendicular to the ground surface, and the handle is pushed and pulled in one motion to move yard debris without altering the orientation of the rake.

The subject invention discloses a yard rake comprising: an elongated, substantially rigid handle extending from a proximal end to a distal end; a rake body secured on the distal end of the handle; a plurality of flexible tines attached to and extending outwardly from a distal end of the rake body, wherein each tine comprises a first segment and a second segment, wherein the first segment of each tine is proximal to and substantially parallel with the rake body and the elongated handle, wherein the second segment of each tine is at an angle of twenty to eighty degrees with respect to the rake body and the elongated handle; wherein the handle is placed at an angle to a ground surface between nineteen and thirty-one degrees, such that the second segments of the plurality of tines are substantially perpendicular to the ground surface, and the handle is pulled in a proximal direction to pull yard debris; and further wherein the handle is pushed in a distal direction to push yard debris with the second segments of the plurality of tines.

The subject invention also discloses a yard rake comprising: an elongated, substantially rigid handle extending from a proximal end to a distal end; a rake body secured on the distal end of the handle; a plurality of flexible tines attached to and extending outwardly from a distal end of the rake body, wherein each tine comprises a first segment and a second segment, wherein the first segment of each tine is proximal to and substantially parallel with the rake body and the elongated handle, wherein the second segment of each tine is at an angle of twenty to eighty degrees with respect to the rake body and the elongated handle; wherein the handle is placed at an angle to a ground surface between nineteen and thirty-one degrees, such that the second segments of the plurality of tines are substantially perpendicular to the ground surface, and the handle is pulled in a proximal direction to pull yard debris; and further wherein the handle is pushed in a distal direction to compress the second segments of the plurality of tines to spring forward and push yard debris away from the rake.

The subject invention further discloses a yard rake comprising: an elongated, substantially rigid handle extending from a proximal end to a distal end; a rake body secured on the distal end of the handle; a plurality of flexible tines attached to and extending outwardly from a distal end of the rake body, wherein each tine comprises a first segment and a second segment, wherein the first segment of each tine is proximal to and substantially parallel with the rake body and the elongated handle, wherein the second segment of each tine is at an angle of twenty to eighty degrees with respect to the rake body and the elongated handle; wherein the handle is placed at an angle to a ground surface between nineteen and thirty-one degrees, such that the second segments of the plurality of tines are substantially perpendicular to the ground surface, and the handle is pushed and pulled in one motion to move yard debris without altering the orientation of the rake.

The subject invention discloses a yard rake comprising: an elongated, substantially rigid handle extending from a proximal end to a distal end; a rake body secured on the distal end of the handle; a plurality of flexible tines attached to and extending outwardly from a distal end of the rake body, wherein each tine comprises a first segment and a second segment, wherein the first segment of each tine is proximal to and substantially parallel with the rake body and the elongated handle, wherein the second segment of each tine is at an angle of sixty degrees with respect to the rake body and the elongated handle; wherein the handle is placed at an angle to a ground surface between ten and fifty degrees, such that the second segments of the plurality of tines are substantially perpendicular to the ground surface, and the handle is pulled in a proximal direction to pull yard debris; and further wherein the handle is pushed in a distal direction to push yard debris with the second segments of the plurality of tines.

The subject invention also discloses a yard rake comprising: an elongated, substantially rigid handle extending from a proximal end to a distal end; a rake body secured on the distal end of the handle; a plurality of flexible tines attached to and extending outwardly from a distal end of the rake body, wherein each tine comprises a first segment and a second segment, wherein the first segment of each tine is proximal to and substantially parallel with the rake body and the elongated handle, wherein the second segment of each tine is at an angle of sixty degrees with respect to the rake body and the elongated handle; wherein the handle is placed at an angle to a ground surface between ten and fifty degrees, such that the second segments of the plurality of tines are substantially perpendicular to the ground surface, and the handle is pulled in a proximal direction to pull yard debris; and further wherein the handle is pushed in a distal direction to compress the second segments of the plurality of tines to spring forward and push yard debris away from the rake.

The subject invention further discloses a yard rake comprising: an elongated, substantially rigid handle extending from a proximal end to a distal end; a rake body secured on the distal end of the handle; a plurality of flexible tines attached to and extending outwardly from a distal end of the rake body, wherein each tine comprises a first segment and a second segment, wherein the first segment of each tine is proximal to and substantially parallel with the rake body and the elongated handle, wherein the second segment of each tine is at an angle of sixty degrees with respect to the rake body and the elongated handle; wherein the handle is placed at an angle to a ground surface between ten and fifty degrees, such that the second segments of the plurality of tines are substantially perpendicular to the ground surface, and the handle is pushed and pulled in one motion to move yard debris without altering the orientation of the rake.

The subject invention discloses a yard rake comprising: an elongated, substantially rigid handle extending from a proximal end to a distal end; a rake body secured on the distal end of the handle; a plurality of flexible tines attached to and extending outwardly from a distal end of the rake body, wherein each tine comprises a first segment and a second segment, wherein the first segment of each tine is proximal to and substantially parallel with the rake body and the elongated handle, wherein the second segment of each tine is at an angle of twenty to eighty degrees with respect to the rake body and the elongated handle; wherein the handle is placed at an angle to a ground surface between ten and fifty degrees, such that the second segments of the plurality of tines are substantially perpendicular to the ground surface, and the handle is pulled in a proximal direction to pull yard debris; and further wherein the handle is pushed in a distal direction to push yard debris with the second segments of the plurality of tines.

The subject invention also discloses a yard rake comprising: an elongated, substantially rigid handle extending from a proximal end to a distal end; a rake body secured on the distal end of the handle; a plurality of flexible tines attached to and extending outwardly from a distal end of the rake body, wherein each tine comprises a first segment and a second segment, wherein the first segment of each tine is proximal to and substantially parallel with the rake body and the elongated handle, wherein the second segment of each tine is at an angle of twenty to eighty degrees with respect to the rake body and the elongated handle; wherein the handle is placed at an angle to a ground surface between ten and fifty degrees, such that the second segments of the plurality of tines are substantially perpendicular to the ground surface, and the handle is pulled in a proximal direction to pull yard debris; and further wherein the handle is pushed in a distal direction to compress the second segments of the plurality of tines to spring forward and push yard debris away from the rake.

The subject invention further discloses a yard rake comprising: an elongated, substantially rigid handle extending from a proximal end to a distal end; a rake body secured on the distal end of the handle; a plurality of flexible tines attached to and extending outwardly from a distal end of the rake body, wherein each tine comprises a first segment and a second segment, wherein the first segment of each tine is proximal to and substantially parallel with the rake body and the elongated handle, wherein the second segment of each tine is at an angle of twenty to eighty degrees with respect to the rake body and the elongated handle; wherein the handle is placed at an angle to a ground surface ten and fifty degrees, such that the second segments of the plurality of tines are substantially perpendicular to the ground surface, and the handle is pushed and pulled in one motion to move yard debris without altering the orientation of the rake.

The subject invention discloses a rake for moving yard debris, the rake comprising: an elongated, substantially rigid handle extending from a proximal end to a distal end; a rake head comprising a proximal end, a distal end, an external side, and an inner side, wherein the rake head is secured on its proximal end to the distal end of the handle; a plurality of flexible tines attached to and extending outwardly from the distal end of the rake head, wherein each tine comprises a first segment and a second segment, wherein a proximal end of the first segment of each tine is attached and substantially parallel with the rake head and the elongated handle, wherein the second segment of each tine is at an angle of twenty to eighty degrees with respect to the rake head and the elongated handle; wherein the handle is placed at an angle to a ground surface between nineteen and thirty-one degrees, such that the second segments of the plurality of tines are substantially perpendicular to the ground surface, and the handle is pulled in a proximal direction to pull yard debris; and further wherein the handle is pushed in a distal direction to push yard debris with the second segments of the plurality of tines.

The subject invention discloses a rake for moving yard debris, the rake comprising: an elongated, substantially rigid handle extending from a proximal end to a distal end; a rake head comprising a proximal end, a distal end, an external side, and an inner side, wherein the rake head is secured on its proximal end to the distal end of the handle; a plurality of flexible tines attached to and extending outwardly from the distal end of the rake head, wherein each tine comprises a first segment and a second segment, wherein a proximal end of the first segment of each tine is attached and substantially parallel with the rake head and the elongated handle, wherein the second segment of each tine is at an angle of twenty to eighty degrees with respect to the rake head and the elongated handle; wherein the handle is placed at an angle to a ground surface between nineteen and thirty-one degrees, such that the second segments of the plurality of tines are substantially perpendicular to the ground surface, and the handle is pulled in a proximal direction to pull yard debris; and further wherein the handle is pushed in a distal direction to compress the second segments of the plurality of tines to spring forward and push yard debris away from the rake.

The subject invention discloses a rake for moving yard debris, the rake comprising: an elongated, substantially rigid handle extending from a proximal end to a distal end; a rake head comprising a proximal end, a distal end, an external side, and an inner side, wherein the rake head is secured on its proximal end to the distal end of the handle; a plurality of flexible tines attached to and extending outwardly from the distal end of the rake head, wherein each tine comprises a first segment and a second segment, wherein a proximal end of the first segment of each tine is attached and substantially parallel with the rake head and the elongated handle, wherein the second segment of each tine is at an angle of twenty to eighty degrees with respect to the rake head and the elongated handle; wherein the handle is placed at an angle to a ground surface between nineteen and thirty-one degrees, such that the second segments of the plurality of tines are substantially perpendicular to the ground surface, and the handle is pushed and pulled in one motion to move yard debris without altering the orientation of the rake.

The subject invention discloses a rake for moving yard debris, the rake comprising: an elongated, substantially rigid handle extending from a proximal end to a distal end; a rake head comprising a proximal end, a distal end, an external side, and an inner side, wherein the rake head is secured on its proximal end to the distal end of the handle; a plurality of flexible tines attached to and extending outwardly from the distal end of the rake head, wherein each tine comprises a first segment and a second segment, wherein a proximal end of the first segment of each tine is attached and substantially parallel with the rake head and the elongated handle, wherein the second segment of each tine is at an angle of sixty degrees with respect to the rake head and the elongated handle; wherein the handle is placed at an angle to a ground surface between ten and fifty degrees, such that the second segments of the plurality of tines are substantially perpendicular to the ground surface, and the handle is pulled in a proximal direction to pull yard debris; and further wherein the handle is pushed in a distal direction to push yard debris with the second segments of the plurality of tines.

The subject invention discloses a rake for moving yard debris, the rake comprising: an elongated, substantially rigid handle extending from a proximal end to a distal end; a rake head comprising a proximal end, a distal end, an external side, and an inner side, wherein the rake head is secured on its proximal end to the distal end of the handle; a plurality of flexible tines attached to and extending outwardly from the distal end of the rake head, wherein each tine comprises a first segment and a second segment, wherein a proximal end of the first segment of each tine is attached and substantially parallel with the rake head and the elongated handle, wherein the second segment of each tine is at an angle of sixty degrees with respect to the rake head and the elongated handle; wherein the handle is placed at an angle to a ground surface between ten and fifty degrees, such that the second segments of the plurality of tines are substantially perpendicular to the ground surface, and the handle is pulled in a proximal direction to pull yard debris; and further wherein the handle is pushed in a distal direction to compress the second segments of the plurality of tines to spring forward and push yard debris away from the rake.

The subject invention discloses a rake for moving yard debris, the rake comprising: an elongated, substantially rigid handle extending from a proximal end to a distal end; a rake head comprising a proximal end, a distal end, an external side, and an inner side, wherein the rake head is secured on its proximal end to the distal end of the handle; a plurality of flexible tines attached to and extending outwardly from the distal end of the rake head, wherein each tine comprises a first segment and a second segment, wherein a proximal end of the first segment of each tine is attached and substantially parallel with the rake head and the elongated handle, wherein the second segment of each tine is at an angle of sixty degrees with respect to the rake head and the elongated handle; wherein the handle is placed at an angle to a ground surface between ten and fifty degrees, such that the second segments of the plurality of tines are substantially perpendicular to the ground surface, and the handle is pushed and pulled in one motion to move yard debris without altering the orientation of the rake.

The subject invention discloses a rake for moving yard debris, the rake comprising: an elongated, substantially rigid handle extending from a proximal end to a distal end; a rake head comprising a proximal end, a distal end, an external side, and an inner side, wherein the rake head is secured on its proximal end to the distal end of the handle; a plurality of flexible tines attached to and extending outwardly from the distal end of the rake head, wherein each tine comprises a first segment and a second segment, wherein a proximal end of the first segment of each tine is attached and substantially parallel with the rake head and the elongated handle, wherein the second segment of each tine is at an angle of twenty to eighty degrees with respect to the rake head and the elongated handle; wherein the handle is placed at an angle to a ground surface between ten and fifty degrees, such that the second segments of the plurality of tines are substantially perpendicular to the ground surface, and the handle is pulled in a proximal direction to pull yard debris; and further wherein the handle is pushed in a distal direction to push yard debris with the second segments of the plurality of tines.

The subject invention discloses a rake for moving yard debris, the rake comprising: an elongated, substantially rigid handle extending from a proximal end to a distal end; a rake head comprising a proximal end, a distal end, an external side, and an inner side, wherein the rake head is secured on its proximal end to the distal end of the handle; a plurality of flexible tines attached to and extending outwardly from the distal end of the rake head, wherein each tine comprises a first segment and a second segment, wherein a proximal end of the first segment of each tine is attached and substantially parallel with the rake head and the elongated handle, wherein the second segment of each tine is at an angle of twenty to eighty degrees with respect to the rake head and the elongated handle; wherein the handle is placed at an angle to a ground surface between ten and fifty degrees, such that the second segments of the plurality of tines are substantially perpendicular to the ground surface, and the handle is pulled in a proximal direction to pull yard debris; and further wherein the handle is pushed in a distal direction to compress the second segments of the plurality of tines to spring forward and push yard debris away from the rake.

The subject invention discloses a rake for moving yard debris, the rake comprising: an elongated, substantially rigid handle extending from a proximal end to a distal end; a rake head comprising a proximal end, a distal end, an external side, and an inner side, wherein the rake head is secured on its proximal end to the distal end of the handle; a plurality of flexible tines attached to and extending outwardly from the distal end of the rake head, wherein each tine comprises a first segment and a second segment, wherein a proximal end of the first segment of each tine is attached and substantially parallel with the rake head and the elongated handle, wherein the second segment of each tine is at an angle of twenty to eighty degrees with respect to the rake head and the elongated handle; wherein the handle is placed at an angle to a ground surface ten and fifty degrees, such that the second segments of the plurality of tines are substantially perpendicular to the ground surface, and the handle is pushed and pulled in one motion to move yard debris without altering the orientation of the rake.

The subject invention discloses a rake for moving yard debris, the rake comprising: an elongated, substantially rigid handle extending from a proximal end to a distal end; a rake head comprising a proximal end, a distal end, an external side, and an inner side, wherein the rake head is secured on its proximal end to the distal end of the handle; a plurality of flexible tines attached to and extending outwardly from the distal end of the rake head, wherein each tine comprises a first segment and a second segment, wherein a proximal end of the first segment of each tine is attached and substantially parallel with the rake head and the elongated handle, wherein the second segment of each tine is at an angle of sixty degrees with respect to the rake head and the elongated handle; wherein the handle is placed at an angle to a ground surface between nineteen and thirty-one degrees, such that the second segments of the plurality of tines are substantially perpendicular to the ground surface, and the handle is pulled in a proximal direction to pull yard debris; and further wherein the handle is pushed in a distal direction to push yard debris with the second segments of the plurality of tines.

The subject invention discloses a rake for moving yard debris, the rake comprising: an elongated, substantially rigid handle extending from a proximal end to a distal end; a rake head comprising a proximal end, a distal end, an external side, and an inner side, wherein the rake head is secured on its proximal end to the distal end of the handle; a plurality of flexible tines attached to and extending outwardly from the distal end of the rake head, wherein each tine comprises a first segment and a second segment, wherein a proximal end of the first segment of each tine is attached and substantially parallel with the rake head and the elongated handle, wherein the second segment of each tine is at an angle of sixty degrees with respect to the rake head and the elongated handle; wherein the handle is placed at an angle to a ground surface between nineteen and thirty-one degrees, such that the second segments of the plurality of tines are substantially perpendicular to the ground surface, and the handle is pulled in a proximal direction to pull yard debris; and further wherein the handle is pushed in a distal direction to compress the second segments of the plurality of tines to spring forward and push yard debris away from the rake.

The subject invention discloses a rake for moving yard debris, the rake comprising: an elongated, substantially rigid handle extending from a proximal end to a distal end; a rake head comprising a proximal end, a distal end, an external side, and an inner side, wherein the rake head is secured on its proximal end to the distal end of the handle; a plurality of flexible tines attached to and extending outwardly from the distal end of the rake head, wherein each tine comprises a first segment and a second segment, wherein a proximal end of the first segment of each tine is attached and substantially parallel with the rake head and the elongated handle, wherein the second segment of each tine is at an angle of sixty degrees with respect to the rake head and the elongated handle; wherein the handle is placed at an angle to a ground surface between nineteen and thirty-one degrees, such that the second segments of the plurality of tines are substantially perpendicular to the ground surface, and the handle is pushed and pulled in one motion to move yard debris without altering the orientation of the rake.

The subject invention discloses a rake for moving yard debris, the rake comprising: an elongated, substantially rigid handle extending from a proximal end to a distal end; a rake head comprising a proximal end, a distal end, an external side, and an inner side, wherein the rake head is secured on its proximal end to the distal end of the handle; a plurality of moveable tines attached to and extending outwardly from the distal end of the rake head in a substantially parallel distal direction, wherein each tine comprises a first segment and a second segment, wherein a proximal end of the first segment of each tine is attached to and substantially parallel with the rake head and the elongated handle, wherein the second segment of each tine extends towards the inner side of the rake head at an angle of twenty to eighty degrees with respect to the external side of the rake head; wherein the handle is placed at an angle to a ground surface between ten and fifty degrees, such that the second segments of the plurality of tines are substantially perpendicular to the ground surface, and the handle is pulled in a proximal direction to pull yard debris; and further wherein the handle is pushed in a distal direction to push yard debris with the second segments of the plurality of tines.

The subject invention discloses a rake for moving yard debris, the rake comprising: an elongated, substantially rigid handle extending from a proximal end to a distal end; a rake head comprising a proximal end, a distal end, an external side, and an inner side, wherein the rake head is secured on its proximal end to the distal end of the handle; a plurality of moveable tines attached to and extending outwardly from the distal end of the rake head in a substantially parallel distal direction, wherein each tine comprises a first segment and a second segment, wherein a proximal end of the first segment of each tine is attached to and substantially parallel with the rake head and the elongated handle, wherein the second segment of each tine extends towards the inner side of the rake head at an angle of one hundred sixty to one hundred degrees with respect to the inner side of the rake head; wherein the handle is placed at an angle to a ground surface between ten and fifty degrees, such that the second segments of the plurality of tines are substantially perpendicular to the ground surface, and the handle is pulled in a proximal direction to pull yard debris; and further wherein the handle is pushed in a distal direction to push yard debris with the second segments of the plurality of tines.

In embodiments of the subject invention, the term “substantially” is defined as at least close to (and can include) a given value or state, as understood by a person of ordinary skill in the art. In one embodiment, the term “substantially” refers to ranges within 10%, preferably within 5%, more preferably within 1%, and most preferably within 0.1% of the given value or state being specified.

In embodiments of the subject invention, the term “relatively” is defined as a comparison of a property, or the proportion of a property between two components.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto. These together with other objects of the invention, along with the various features of novelty, which characterize the invention, are pointed out with particularity in the claims annexed to and forming a part of this disclosure.

### BRIEF DESCRIPTION OF THE DRAWINGS

Advantages of the present invention will be apparent from the following detailed description of embodiments thereof, which description should be considered in conjunction with the accompanying drawings, in which:

FIG. 1 illustrates an isometric top view of a reversible rake.

FIG. 2 illustrates a top view of the reversible rake.

FIG. 3 illustrates a bottom side view of the reversible rake.

FIG. 4 illustrates a left side view of the reversible rake.

FIG. 5 illustrates a right side view of the reversible rake.

FIG. 6 illustrates a front view of the reversible rake.

FIG. 7 illustrates a rear view of the reversible rake.

### DETAILED DESCRIPTION OF THE EMBODIMENTS

While several variations of the present invention have been illustrated by way of example in particular embodiments, it is apparent that further embodiments could be developed within the spirit and scope of the present invention, or the inventive concept thereof. However, it is to be expressly understood that such modifications and adaptations are within the spirit and scope of the present invention, and are inclusive, but not limited to the following appended claims as set forth.

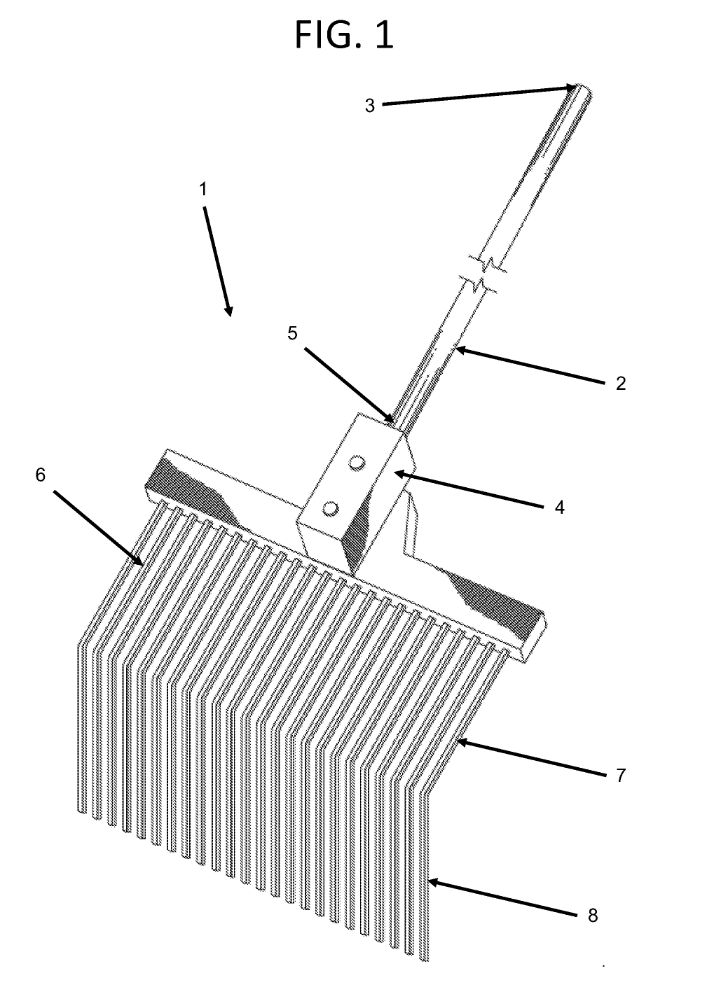

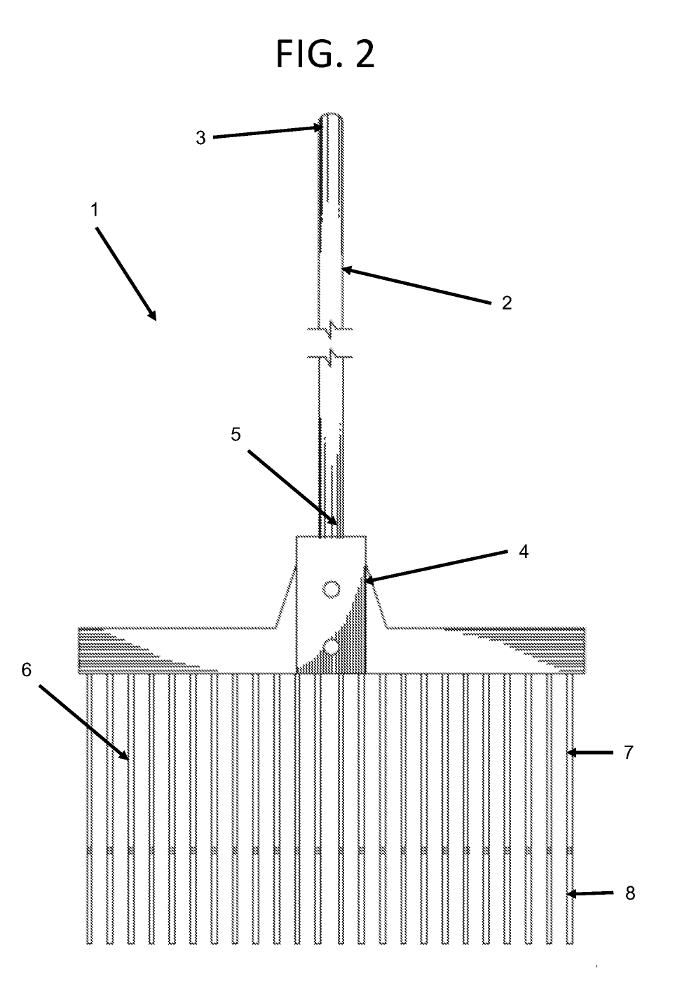

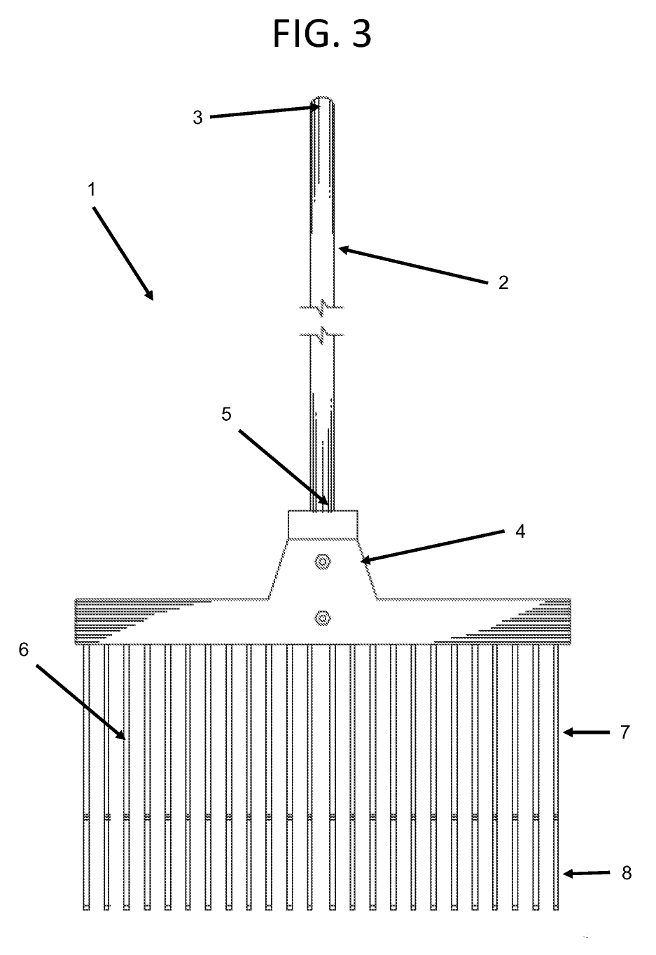

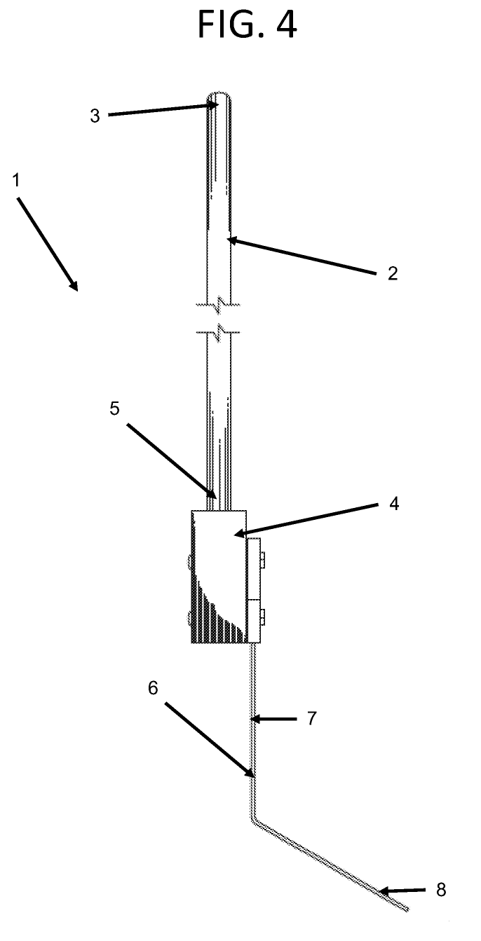

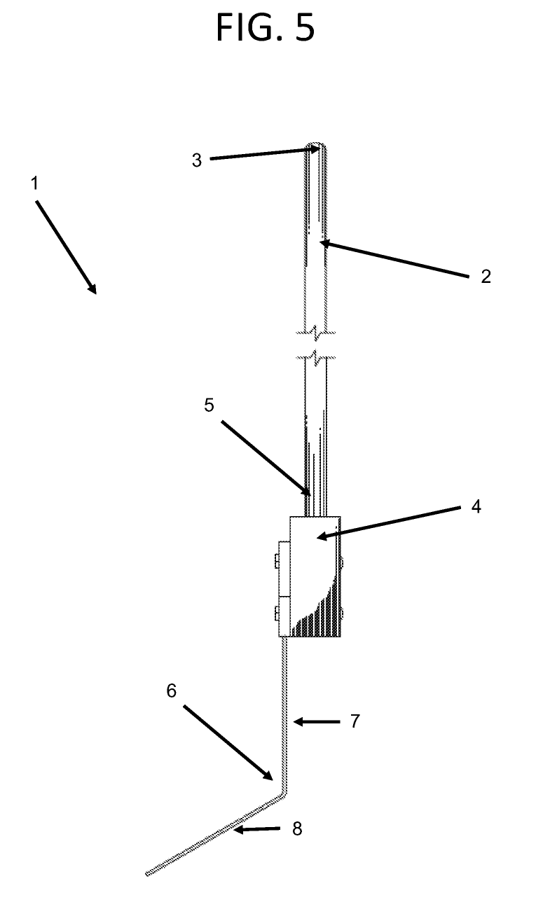

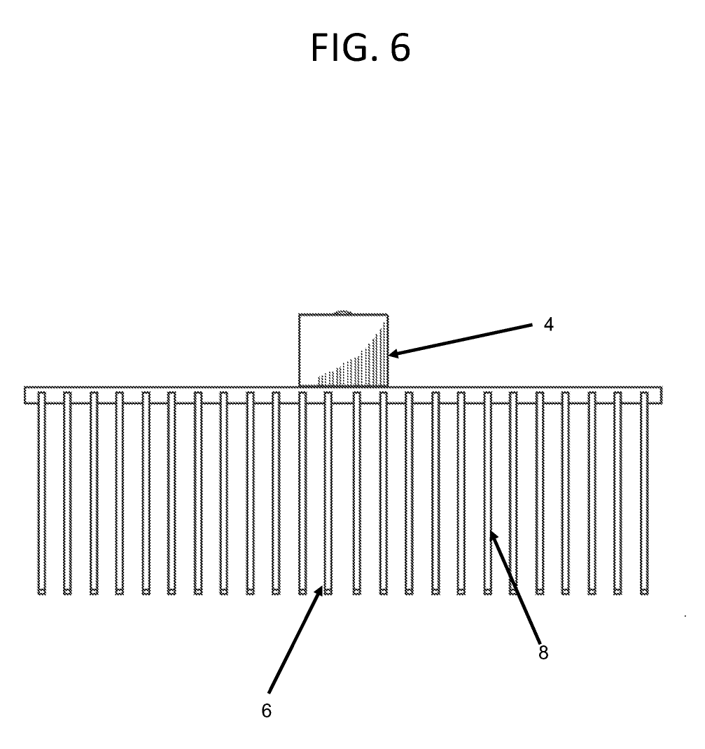

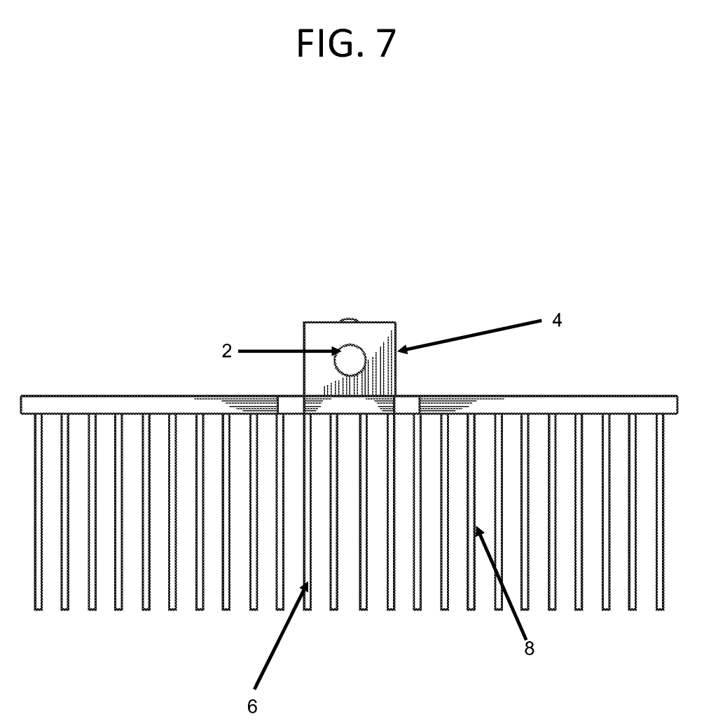

As illustrated in FIGS. 1-7, the subject invention discloses a reversible yard or landscaping rake 1. The rake 1 has an elongated, relatively rigid handle 2 on the proximal end 3 for grasping with one or both hands. In embodiments of the subject invention, the handle 2 may be forty to seventy inches in length from the proximal end 3 to the distal end 5.

A rake body 4 is attached to the distal end 5 of the handle 2. In embodiments of the subject invention, the rake body 4 may be sixteen to twenty-four inches in width.

A plurality of flexible tines 6 extend outwardly in a distal direction from the rake body 4. Each tine 6 includes a first segment 7 that is proximal to and substantially parallel with the rake body 4 and the elongated handle 2. Each tine 6 further includes a second segment 8 that is distal to and at an angle with the rake body 4 and the handle 2. In embodiments of the subject invention, the angle of the second segment 8 of the tines 6 with the rake body 4 may be fifty to seventy degrees. In other embodiments of the subject invention, the tines 6 may be composed of metal or plastic this is compressible. In further embodiments of the subject invention, the first section 7 of the tines 6 may be five to eight inches in length. In additional embodiments of the subject invention, the second section 8 of the tines 6 may be five to ten inches in length.

In embodiments of the subject invention, the rake 1 may have twenty to thirty tines 6. In the preferred embodiment the tines 6 have a thickness of approximately 0.0620 inches, a width of 3/16 inches, a blue polished grade, and a Rockwell hardness of C48-51.

In pulling use, the rake 1 is held with the handle 2 at an angle of twenty to thirty degrees with respect to the ground surface. This rake 1 orientation places the second segment 8 of the tines 6 relatively perpendicular to the ground surface. The perpendicular position allows a user to exert a pulling force equivalent to a traditional rake.

In pushing use, the rake 1 handle 2 is pushed downward and distally away from the handle 2. This pushing motion causes the first segment 7 of the tines 6 to bend and create a spring action that pushes the second segment 8 of the tines 6 away from the distal end 5 of the handle 2, projecting yard debris in front of the tines 6 forward and away.

The subject invention permits a user to change between these pull and push motions in one stroke, without the need to change the orientation of the rake 1. The rake 1 may be pulled and pushed quickly back and forth, to stir up yard debris, uprooting leaves, sticks, and embedded debris as needed. The rake 1 of the subject invention permits usage that is less tiring and requires less effort to collect fallen leaves. The rake 1 of the subject invention permits pushing movement of large or heavy piles of leaves with minimal effort. The height of the rake tines 6 permits a greater build-up of yard debris underneath, creating a more efficient pulling.

The many aspects and benefits of the invention are apparent from the detailed description, and thus, it is intended for the following claims to cover such aspects and benefits of the invention, which fall within the scope, and spirit of the invention. In addition, because numerous modifications and variations will be obvious and readily occur to those skilled in the art, the claims should not be construed to limit the invention to the exact construction and operation illustrated and described herein. Accordingly, all suitable modifications and equivalents should be understood to fall within the scope of the invention as claimed here.

What is claimed is:

1. A yard rake comprising:
(a) an elongated, substantially rigid handle extending from a proximal end to a distal end;
(b) a rake body secured on the distal end of the handle;
(c) a plurality of flexible tines attached to and extending outwardly from a distal end of the rake body, wherein each tine comprises a first segment and a second segment, wherein the first segment of each tine is proximal to and substantially parallel with the rake body and the elongated handle, wherein the second segment of each tine is at an angle of sixty degrees with respect to the rake body and the elongated handle;
(d) wherein the handle is placed at an angle to a ground surface between nineteen and thirty-one degrees, such that the second segments of the plurality of tines are substantially perpendicular to the ground surface, and the handle is pulled in a proximal direction to pull yard debris; and
(e) further wherein the handle is pushed in a distal direction to push yard debris with the second segments of the plurality of tines.

2. A yard rake comprising:
(a) an elongated, substantially rigid handle extending from a proximal end to a distal end;
(b) a rake body secured on the distal end of the handle;
(c) a plurality of flexible tines attached to and extending outwardly from a distal end of the rake body, wherein each tine comprises a first segment and a second segment, wherein the first segment of each tine is proximal to and substantially parallel with the rake body and the elongated handle, wherein the second segment of each tine is at an angle of sixty degrees with respect to the rake body and the elongated handle;
(d) wherein the handle is placed at an angle to a ground surface between nineteen and thirty-one degrees, such that the second segments of the plurality of tines are substantially perpendicular to the ground surface, and the handle is pulled in a proximal direction to pull yard debris; and
(e) further wherein the handle is pushed in a distal direction to compress the second segments of the plurality of tines to spring forward and push yard debris away from the rake.

3. A yard rake comprising:
(a) an elongated, substantially rigid handle extending from a proximal end to a distal end;
(b) a rake body secured on the distal end of the handle;
(c) a plurality of flexible tines attached to and extending outwardly from a distal end of the rake body, wherein each tine comprises a first segment and a second segment, wherein the first segment of each tine is proximal to and substantially parallel with the rake body and the elongated handle, wherein the second segment of each tine is at an angle of sixty degrees with respect to the rake body and the elongated handle;
(d) wherein the handle is placed at an angle to a ground surface between nineteen and thirty-one degrees, such that the second segments of the plurality of tines are substantially perpendicular to the ground surface, and the handle is pushed and pulled in one motion to move yard debris without altering the orientation of the rake.

4. The yard rake of claim 1, wherein the first segment of each tine is five to eight inches in length.

5. The yard rake of claim 1, wherein the second segment of each tine is five to ten inches in length.

6. The yard rake of claim 1, wherein the handle is forty to seventy inches in length.

7. The yard rake of claim 1, wherein the rake body is sixteen to twenty-four inches in width.

8. The yard rake of claim 1, wherein each tine has a thickness of 0.04 to 0.07 inches.

9. The yard rake of claim 1, wherein each tine has a width of 0.15 to 0.30 inches.

10. The yard rake of claim 1, wherein each tine has a Rockwell harness of C48-51.

11. The yard rake of claim 3, wherein the first segment of each tine is five to eight inches in length.

12. The yard rake of claim 3, wherein the second segment of each tine is five to ten inches in length.

13. The yard rake of claim 3, wherein the handle is forty to seventy inches in length.

14. The yard rake of claim 3, wherein the rake body is sixteen to twenty-four inches in width.

15. The yard rake of claim 3, wherein each tine has a thickness of 0.04 to 0.07 inches.

16. The yard rake of claim 3, wherein each tine has a width of 0.15 to 0.30 inches.

17. The yard rake of claim 3, wherein each tine has a Rockwell harness of C48-51.
